(19) United States
(12) Patent Application Publication
(10) Pub. No.: US 2005/0186507 A1
(43) Pub. Date: Aug. 25, 2005

(54) Photoresist composition

(75) Inventor: James F. Cameron, Cambridge, MA (US)

Correspondence Address: Peter F. Corless;Edwards & Angell, LLP, P.O. Box 55874, Boston, MA, 02205, US

(73) Assignee: Rohm and Haas Electronic Materials LLC, Marlborough, MA (US)

(21) Appl. No.: 11/062,538

(22) Filed: Feb. 22, 2005

Related U.S. Application Data
(60) Provisional application No. 60/546,838, filed on Feb. 22, 2004.

(51) Int. Cl. G03C 1/492

(52) U.S. Cl. 430/270.1

(57) ABSTRACT

New photoresists are provided that comprise a blend of at least two distinct phenolic polymers, wherein each polymer has distinct photoacid labile groups from the other polymer. One or preferably both distinct phenolic resins of the blend have extremely low polydispersity values. Photoresists of the invention can exhibit excellent resolution of a formed image upon lithographic processing.

### BACKGROUND OF THE INVENTION

1. Field of the Invention

The present invention relates to new photoresists that comprise a blend of at least two distinct phenolic polymers, wherein each polymer has distinct photoacid labile groups from the other polymer. Phenolic resin blends of the invention are characterized in part by one or more resins of the blend having low polydispersity values.

2. Background

Photoresists are photosensitive films used for transfer of images to a substrate. A coating layer of a photoresist is formed on a substrate and the photoresist layer is then exposed through a photomask to a source of activating radiation. The photomask has areas that are opaque to activating radiation and other areas that are transparent to activating radiation. Exposure to activating radiation provides a photoinduced chemical transformation of the photoresist coating to thereby transfer the pattern of the photomask to the photoresist coated substrate. Following exposure, the photoresist is developed to provide a relief image that permits selective processing of a substrate. See, generally, Deforest, Photoresist Materials and Processes, McGraw Hill Book Company, New York, ch. 2, 1975 and by Moreau, Semiconductor Lithography, Principles, Practices and Materials, Plenum Press, New York, ch. 2 and 4, both incorporated herein by reference for their teaching of photoresist compositions and methods of making and using the same.

While currently available photoresists are suitable for many applications, current resists also can exhibit significant shortcomings, particularly in high performance applications such as formation of highly resolved sub-micron and sub-half micron features.

It thus would be desirable to have new photoresist compositions, particularly resist compositions that could exhibit enhanced resolution, particularly at deep UV (248 nm) imaging.

### SUMMARY OF THE INVENTION

We now provide new chemically-amplified positive photoresist compositions that comprises a resin blend of at least two distinct phenolic polymers with photoacid labile groups.

At least one and preferably both of the resins of the blend have low polydispersity (Mw/Mn) values, particularly 1.4 or less, more preferably 1.3, 1.25 or 1.2 or less. References herein to polydispersity values are as determined by gel permeation chromatography.

We have found that photoresist compositions of the invention can provide exceptional resolution upon lithographic processing with 248 nm exposure radiation. In particular, resists of the invention can form highly resolved sub-quarter-micron lines and other features.

Phenolic resins of the present resin blends may comprise repeat units other than phenolic groups or functionalized phenolic groups. For instance, the present resins may comprises polymerized acrylate groups including photoacid-labile acrylate such as polymerized t-butyl acrylate, t-butylmethacrylate, methyladamantylacrylate, and the like. Resins also may comprise units that are relatively inert to lithographic processing such as polymerized styrene units and the like.

Suitable photoacid labile groups of the present resins include acetal and ester groups. Such photoacid-labile esters and acetal moieties may be suitably grafted onto phenolic —OH groups of a formed resin or a phenolic monomer. For instance, an ester grafted onto a hydroxy group is a preferred acid-labile group (de-esterification occurs in the presence of photogenerated acid to provide developer-solublizing carboxy group). Such esters may be provided e.g. by reaction of a haloacetate compound (e.g. tert-butyl chloroacetate) with a phenolic hydroxy group. Acetal groups also are preferred photoacid-labile groups; for example a vinyl ether compound may be grafted onto a phenolic hydroxy moiety to provide a photoacid-labile acetal group. Suitable vinyl ether reagents to provide a photoacid-labile acetal group include compounds having at least one —(CH═CH)—O— group such as ethylvinyl ether and the like

The invention also provides methods for forming relief images, including methods for forming a highly resolved relief image such as a pattern of lines where each line has essentially vertical sidewalls and a line width of about 0.25 microns or less, or even about 0.20 microns or less. The invention further provides articles of manufacture comprising substrates such as a microelectronic semiconductor wafer substrate having coated thereon the photoresists and relief images of the invention.

Other aspects of the invention are disclosed infra.

### DETAILED DESCRIPTION OF THE INVENTION

Preferred resins of photoresists and resin blends of the invention include the following identified immediately below “Structures 1 through 6” where the resin structure appears below the “Structure 1” and the like designation. These “Structure 1” and the like designations are referred to elsewhere herein to designate the specified resin.

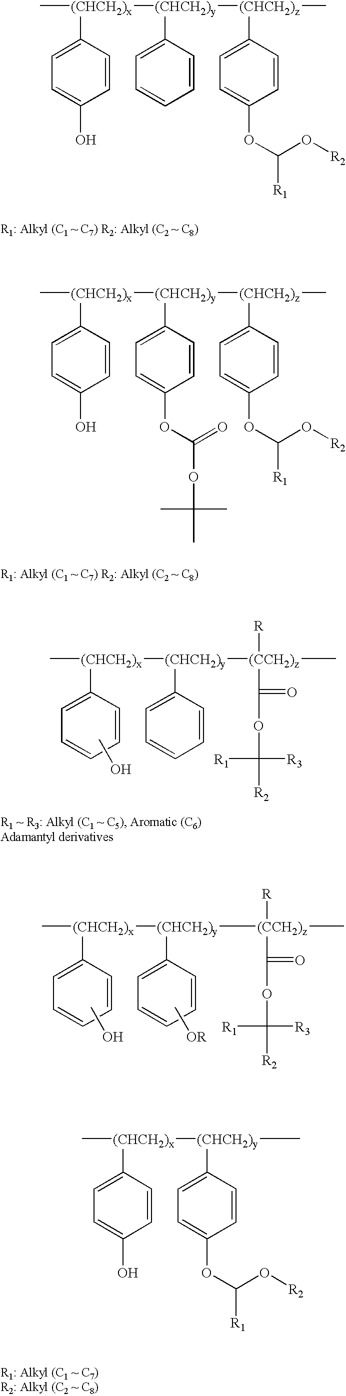

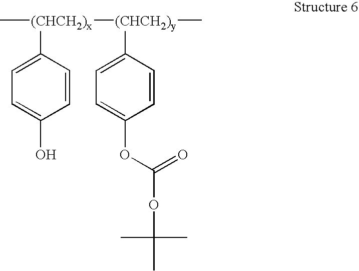

The relative amounts of resin blend members can suitably vary widely. For example, in a two resin blend, each of the two resin may be present in an amount of from 5 to 95 weight percent based on total weight of the resin blend, more typically each resin is present in an amount of from 10 to 90 weight percent or 20 to 80 weight percent based on total weight of the resin blend.

Polymers of the invention can be prepared by free radical polymerization, e.g., by reaction of a plurality of monomers to provide the various units as discussed above in the presence of a radical initiator under an inert atmosphere (e.g., N₂ or argon) and at elevated temperatures such as about 70° C. or greater, although reaction temperatures may vary depending on the reactivity of the particular reagents employed and the boiling point of the reaction solvent (if a solvent is employed). Suitable reaction temperatures for any particular system can be readily determined empirically by those skilled in the art based in view of the present disclosure.

A reaction solvent may be employed if desired. Suitable solvents include alcohols such as propanols and butanols and aromatic solvents such as benzene, chlorobenzene, toluene and xylene. Dimethylsulfoxide and dimethylformamide are also suitable. The polymerization reaction also may be run neat.

A variety of free radical initiators may be employed to prepare the copolymers of the invention. For example, azo compounds may be employed such as azo-bis-2,2′-isobutyronitrile (AIBN) and 1,1′-azobis(cyclohexanecarbonitrile). Peroxides, peresters, peracids and persulfates also can be employed.

Preferably the copolymer of the invention will have a weight average molecular weight (Mw) of 1,000 to about 100,000, more preferably about 2,000 to about 30,000.

As discussed above, one or more or all members of a resin blend of the invention will have extremely low polydispersity values, particularly 1.4 or less, more preferably 1.3 or less or 1.2 or less.

Such low polydispersity resins can be prepared by a number of methods. A formed resins can be treated, e.g. by fractionation, chromatography or organic solvent washing, to provide a more homogenous and lower polydispersity resin. After such purification treatment, the polydispersity of the resin can be evaluated (via gel permeation chromatography) to determine if the targeted polydispersity value has been realized.

The polymer synthesis also may directly provide phenolic resins useful in the blends and resists of the invention with low polydispersity values. In particular, in a free radical polymerization, a free radical control agent such as a piperdinyl (N-oxy) agent including TEMPO (which is commercially available) can be employed to produce a low polydispersity phenolic polymer. Use of such free radical polymerization control agents is disclosed in U.S. Pat. No. 6,107,425.

The thus formed phenolic resin can be functionalized as desired, e.g. one or more photoacid labile groups can be grafted onto phenolic oxygens as discussed above. The formed polymer also may be further purified as discussed above (e.g. fractionation, organic solvent wash, chromatography) to provide a resin with an lower polydispersity value.

As discussed above, the phenolic resin blends of the invention are highly useful as the resin component in particularly chemically- amplified positive resists. Photoresists of the invention in general comprise one or more photoacid generator compounds and a resin blend of at least two distinct resins as discussed above.

The resin blend should be used in an amount sufficient to render a coating layer of the resist developable with an aqueous alkaline developer.

Photoresists of the invention should comprise one or more photoacid generators (i.e. “PAG”) employed in an amount sufficient to generate a latent image in a coating layer of the resist upon exposure to activating radiation.

Generally preferred PAGs for use in the photoresists of the invention are onium salts, particularly iodonium and sulfonium PAGs. Suitable onium salt PAGs are disclosed in U.S. Pat. No. 6,200,728 to Cameron et al.

Two particularly preferred onium PAGs for use in resists of the invention are the following iodonium PAGS 1 and 2:

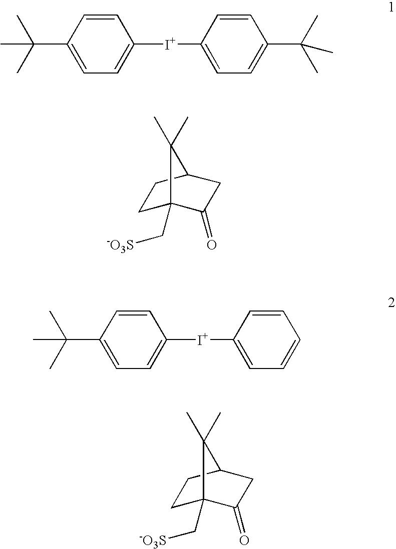

Such iodonium PAGs can be prepared as disclosed in European Patent Application 96118111.2 (publication number 0783136), which details the synthesis of above PAG 1.

Also suitable are the above two iodonium compounds complexed with anions other than the above-depicted camphorsulfonate groups. In particular, preferred anions include those of the formula RSO₃— where R is adamantane, alkyl (e.g. C₁₋₁₂ alkyl) and perfluoroalkyl such as perfluoro (C₁₋₁₂alkyl), particularly perfluorooctanesulfonate, perfluorobutanesulfonate and the like.

Another groups of preferred photoacid generator compounds for use in resists of the invention are imidosulfonates such as compounds of the following formula: 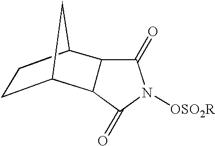
wherein R is camphor, adamantane, alkyl (e.g. C₁₋₁₂ alkyl) and perfluoroalkyl such as perfluoro(C₁₋₁₂alkyl), particularly perfluorooctanesulfonate, perfluorononanesulfonate and the like. A specifically preferred PAG is N-[(perfluorooctanesulfonyl)oxy]-5-norbornene-2,3-dicarboximide.

Other suitable PAGS including sulfonated esters and sulfonyloxy ketones. See J. of Photopolymer Science and Technology, 4(3):337-340 (1991), for disclosure of suitable sulfonate PAGS, including benzoin tosylate, t-butylphenyl alpha-(p-toluenesulfonyloxy)-acetate and t-butyl alpha-(p-toluenesulfonyloxy)-acetate. Preferred sulfonate PAGs are also disclosed in U.S. Pat. No. 5,344,742 to Sinta et al.

Other useful acid generators include the family of nitrobenzyl esters, and the s-triazine derivatives. Suitable s-triazine acid generators are disclosed, for example, in U.S. Pat. No. 4,189,323.

A preferred optional component of resist compositions of the invention is a dye compound. Preferred dyes can enhance resolution of the patterned resist image, typically by reducing reflections and the effects thereof (e.g. notching) of the exposure radiation. Preferred dyes include substituted and unsubstituted phenothiazine, phenoxazine, anthracene and anthrarobin compounds. Preferred substituents of substituted phenothiazine, phenoxazine, anthracene and anthrarobin include e.g. halogen, C₁₋₁₂ alkyl, C₁₋₁₂ alkoxy, C₂₋₁₂ alkenyl, C₁₋₁₂ alkanoyl such as acetyl, aryl such as phenyl, etc. Copolymers of such compounds also may be used as a dye, e.g., an anthracene acrylate polymer or copolymer. A curcumin dye also may be used for some applications. Rather than a separate composition component, such dyes also can be incorporated directly into the copolymer, e.g. where two adjacent R¹ moieties of units 2) above together form a fused ring to provide an acenaphthyl moiety or the like. In addition to reducing reflections in deep U.V. exposures, use of a dye may expand the spectral response of the compositions of invention including beyond 248 nm or other deep UV wavelengths, such as to 365 nm or 436 nm exposure wavelengths.

Another preferred optional additive is an added base, particularly tetrabutylammonium hydroxide (TBAH), or the lactate salt of TBAH, which can enhance resolution of a developed resist relief image. The added base is suitably used in relatively small amounts, e.g. about 1 to 20 percent by weight relative to the photoactive component (PAG).

Photoresists of the invention also may contain other optional materials. For example, other optional additives include anti-striation agents, plasticizers, speed enhancers, etc. Such optional additives typically will be present in minor concentration in a photoresist composition except for fillers and dyes which may be present in relatively large concentrations such as, e.g., in amounts of from about 5 to 30 percent by weight of the total weight of a resist's dry components.

Photoresist compositions of the invention can be readily prepared by those skilled in the art. For example, a photoresist composition of the invention can be prepared by dissolving the components of the photoresist in a suitable solvent such as, for example, ethyl lactate, a glycol ether such as 2-methoxyethyl ether (diglyme), ethylene glycol monomethyl ether, ethylene glycol monomethyl ether, propylene glycol monomethyl ether; a Cellosolve ester such as methyl ethyl ketone; and 3-ethoxy ethyl propionate. Typically, the solids content of the composition varies between about 5 and 35 percent by weight of the total weight of the photoresist composition. The resin binder and PAG components should be present in amounts sufficient to provide a film coating layer and formation of good quality latent and relief images. See Example 8 which follows for exemplary preferred amounts of resist components.

Resist compositions of the invention are used in accordance with generally known procedures. The liquid coating compositions of the invention are applied to a substrate such as by spinning, dipping, roller coating or other conventional coating technique. When spin coating, the solids content of the coating solution can be adjusted to provide a desired film thickness based upon the specific spinning equipment utilized, the viscosity of the solution, the speed of the spinner and the amount of time allowed for spinning.

The resist compositions of the invention are suitably applied to substrates conventionally used in processes involving coating with photoresists. For example, the composition may be applied over silicon or silicon dioxide wafers for the production of microprocessors and other integrated circuit components. Aluminum-aluminum oxide, gallium arsenide, ceramic, quartz or copper substrates also may be employed. Substrates used for liquid crystal display and other flat panel display applications are also suitably employed, e.g. glass substrates, indium tin oxide coated substrates and the like.

Following coating of the photoresist onto a surface, it is dried by heating to remove the solvent until preferably the photoresist coating is tack free. Thereafter, it is imaged through a mask in conventional manner. The exposure is sufficient to effectively activate the photoactive component of the photoresist system to produce a patterned image in the resist coating layer and, more specifically, the exposure energy typically ranges from about 1 to 300 mJ/cm², dependent upon the exposure tool and the components of the photoresist composition.

Coating layers of the resist compositions of the invention are preferably photoactivated by an exposure wavelength in the deep U.V. range i.e., typically in the range of about 300 nm or less, particularly about 248 nm.

Following exposure, the film layer of the composition is preferably baked at temperatures ranging from about 70° C. to about 160° C. Thereafter, the film is developed. The exposed resist film is rendered positive working by employing a polar developer, preferably an aqueous based developer such as an inorganic alkali exemplified by sodium hydroxide, potassium hydroxide, sodium carbonate, sodium bicarbonate, sodium silicate, sodium metasilicate; quaternary ammonium hydroxide solutions such as a tetra-alkyl ammonium hydroxide solution; and the like. In general, development is in accordance with art recognized procedures.

Following development of the photoresist coating over the substrate, the developed substrate may be selectively processed on those areas bared of resist, for example by chemically etching or plating substrate areas bared of resist in accordance with procedures known in the art. For the manufacture of microelectronic substrates, e.g., the manufacture of silicon dioxide wafers, suitable etchants include a gas etchant, e.g. a chlorine or fluorine-based etchant such a CF₄ or CF₄/CHF₃ etchant applied as a plasma stream. After such processing, resist may be removed from the processed substrate using known stripping procedures.

All documents mentioned herein are fully incorporated herein by reference.

The following non-limiting examples are illustrative of the invention.

### EXAMPLE 1

### Photoresist Preparation and Lithographic Processing

A resist of the invention is prepared by admixing the following components where amounts are expressed as weight percent of solids (all components except solvent) and the resist is formulated as an 84.4 weight percent fluid formulation:

| Component | Amount |
|---|---|
| First phenolic resin | 6 |
| Second phenolic resin | 4 |
| PAG | 5.2 |
| Basic Additive | 0.3 |
| Surfactant | 0.1 |
| Solvent | to 84.4 percent formulation |

In the resist, the first phenolic resin is the polymer of the above Structure 1 wherein R₁ and R₂ are each ethyl; the second phenolic polymer is the polymer of the above Structure 2 where R₁ and R₂ are each ethyl. The PAG is triphenylsulfonium perfluorobutane sulfonate. The basic additive is tetrabutylammonium lactate. The surfactant is R08. The solvent is ethyl lactate.

The formulated resist composition is spin coated onto 8 inch silicon wafers having a crosslinked organic antireflective layer. The applied resist is softbaked via a vacuum hotplate at 110° C. for 90 seconds. The resist coating layer is exposed through a photomask at 248 nm, and then the exposed wafer is post-exposure baked at 120° C. The imaged resist layer is then developed by treatment with an aqueous 0.26 N tetramethylammonium hydroxide solution.

The foregoing description of the invention is merely illustrative thereof, and it is understood that variations and modification can be made without departing from the spirit or scope of the invention as set forth in the following claims.

1. A positive-acting photoresist composition comprising:
a) one or more photoacid generator compounds; and
b) a resin component that comprises a first phenolic resin and a second phenolic resin, the first and second resin being different,
the first resin comprising i) phenolic groups, ii) ester photoacid-labile groups, and iii) acetal photoacid-labile groups, and wherein the first resin has a polydispersity of about 1.4 or less.

2. The photoresist composition of claim 1 wherein the first resin has a polydispersity of about 1.3 or less.

3. The photoresist composition of claim 1 wherein the second resin has a polydispersity of about 1.2 or less.

4. The photoresist composition of claim 1 wherein the ester and acetal photoacid-labile groups of the first resin are covalently linked to phenolic resin units.

5. The photoresist composition of claim 1 wherein the second resin comprises phenolic groups and photoacid-labile ester groups.

6. The photoresist composition of claim 5 wherein the second resin has a polydispersity of about 1.4 or less.

7. The photoresist composition of claim 5 wherein the second resin has a polydispersity of about 1.2 or less.

8. A method for forming a photoresist relief image, comprising:
A) applying a layer of a photoresist composition of claim 1 on a substrate; and
B) exposing and developing the photoresist layer on the substrate to yield a photoresist relief image.

9. An article of manufacture comprising a substrate that comprises a photoresist composition of claim 1.

10. A resin blend that a first phenolic resin and a second phenolic resin, the first and second resin being different,
the first resin comprising i) phenolic groups, ii) ester photoacid-labile groups, and iii) acetal photoacid-labile groups, and wherein the first resin has a polydispersity of about 1.3 or less; and
the second resin comprises phenolic groups and photoacid-labile ester groups and has a polydispersity of about 1.3 or less.
